(19) United States
(12) Patent Application Publication
(10) Pub. No.: US 2012/0014347 A1
(43) Pub. Date: Jan. 19, 2012

(54) TRANSMISSION CONTROLLING METHOD, WIRELESS TRANSMITTER, WIRELESS RECEIVER, AND COMMUNICATION SYSTEM

(75) Inventor: Yoshinori TANAKA, Kawasaki (JP)

(73) Assignee: FUJITSU LIMITED, Kawasaki-shi (JP)

(21) Appl. No.: 13/246,329

(22) Filed: Sep. 27, 2011

Related U.S. Application Data
(63) Continuation of application No. PCT/JP2009/056507, filed on Mar. 30, 2009.

(51) Int. Cl. H04W 72/04

(52) U.S. Cl. 370/329

(57) ABSTRACT

A wireless transmitter that transmits data to a wireless receiver generates a plurality of data blocks based on the data destined for the wireless receiver; encodes and modulates each of the plurality of data blocks in accordance with an encoding scheme and a modulating scheme that are to be applied; and transmits the plurality of data blocks encoded and modulated using a wireless resource. In the generation of the data block, the size of each of the plurality of data blocks is adjusted by dividing the data destined for the wireless receiver such that an amount of data of each of the plurality of data blocks encoded and modulated is equal to or less than an amount of maximum data that the wireless transmitter is able to transmit using the wireless resource when the encoding scheme and the modulating scheme are applied.

### CROSS-REFERENCE TO RELATED APPLICATION

This application is a continuation Application of international application No. PCT/JP2009/056507 filed on Mar. 30, 2009, now pending, the entire contents of which are wholly incorporated by reference.

### FIELD

The embodiments discussed herein are related to a transmission controlling method, a wireless transmitter, a wireless receiver, and a communication system.

### BACKGROUND

Long Term Evolution (LTE) is a standard on high-speed mobile communication now being standardized for smooth and stepwise transition from Third Generation (3G) mobile communication to Fourth Generation (4G) mobile communication.

In LTE wireless communication system, a Base Station (BS) transmits data to a User Equipment (UE) using a wireless resource for data transmission. At that time, with the intention of efficient use of the wireless resource, the BS allocates the wireless resource to the UE by means of either or both time scheduling and frequency scheduling.

The techniques related to LTE is disclosed in following Non-Patent Literatures 1-3.
Non-Patent Literature 1: 3GPP TS 36.211 v8.3.0, [online], May, 2008, 3rd Generation Partnership Project, retrieved on 17 Oct. 2008
Non-Patent Literature 2: 3GPP TS 36.212 v8.3.0, [online], May, 2008, 3rd Generation Partnership Project, retrieved on 17 Oct. 2008
Non-Patent Literature 3: 3GPP TS 36.213 v8.3.0, [online], May, 2008, 3rd Generation Partnership Project, retrieved on 17 Oct. 2008

### SUMMARY

(1) According to an aspect of the embodiments, a method includes a transmission controlling method for a wireless transmitter which transmits data to a wireless receiver, the transmission controlling method includes: generating a plurality of data blocks based on the data destined for the wireless receiver; encoding and modulating each of the plurality of data blocks in accordance with an encoding scheme and a modulating scheme that are to be applied; and transmitting the plurality of data blocks encoded and modulated using a wireless resource, wherein the generating of the plurality of data blocks including adjusting the size of each of the plurality of data blocks by dividing the data destined for the wireless receiver such that an amount of data of each of the plurality of data blocks encoded and modulated is equal to or less than an amount of maximum data that the wireless transmitter is able to transmit using the wireless resource when the encoding scheme and the modulating scheme are applied.

(2) According to an aspect of the embodiments, an apparatus includes a wireless transmitter that transmits data to a wireless receiver, the wireless transmitter includes: a data block generator that generates a plurality of data blocks based on the data destined for the wireless receiver; a transmitting data generator that encodes and modulates each of the plurality of data blocks in accordance with an encoding scheme and a modulating scheme that are to be applied; and a transmitter that transmits the plurality of data blocks encoded and modulated by the transmitting data generator using a wireless resource, wherein the transmitting data generator adjusts the size of each of the plurality of data blocks by dividing the data destined for the wireless receiver such that an amount of data of each of the plurality of data blocks encoded and modulated is equal to or less than an amount of maximum data that the wireless transmitter is able to transmit using the wireless resource when the encoding scheme and the modulating scheme are applied.

(3) According to an aspect of the embodiments, an apparatus includes a wireless receiver that receives data from a wireless transmitter, the receiving device includes: a receiver that receives, from the wireless transmitter, a plurality of data blocks into which the data is divided such that an amount of data of each of the plurality of data blocks encoded and modulated in an encoding scheme and a modulating scheme is equal to or less than an amount of maximum data that the wireless transmitter is able to transmit using a wireless resource when the encoding scheme and the modulating scheme are applied a determining section that determines whether the data is correctly received in units of the plurality of data blocks; a retransmitting controller that requests the wireless transmitter to retransmit each of the plurality of data blocks according to the result of the determination in the determining section.

(4) According to an aspect of the embodiments, an apparatus includes a communication system including a wireless receiver and a wireless transmitter which transmits data to the wireless, the system includes: a data block generator that generates a plurality of data blocks based on the data destined for the wireless receiver; a transmitting data generator that encodes and modulates each of the plurality of data blocks in accordance with an encoding scheme and a modulating scheme that are to be applied; and a transmitter that transmits the plurality of data blocks using a wireless resource, wherein the transmitting data generator adjusts the size of each of the plurality of data blocks by dividing the data destined for the wireless receiver such that an amount of data of each of the plurality of data blocks encoded and modulated is equal to or less than an amount of maximum data that the wireless transmitter is able to transmit using the wireless resource when the encoding scheme and the modulating scheme are applied.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a diagram illustrating an example of a wireless resource extending in the frequency axis direction and in the time axis direction;

FIG. 2 is a diagram illustrating an example of controlling data communication between a base station and a user equipment;

FIG. 3A and FIG. 3B are diagrams illustrating an example of allocating DL data to a wireless resource;

FIG. 4A and FIG. 4B are diagrams illustrating an example of allocating DL data to a wireless resource;

FIG. 5 is a diagram illustrating an example of the configuration of a wireless communication system according to a first embodiment;

FIG. 6 is a block diagram schematically illustrating an example of the configuration of the BS of FIG. 5;

FIG. 7 is a block diagram schematically illustrating an example of the configuration of the UE of FIG. 5;

FIG. 8A and FIG. 8B are diagrams illustrating an example of a controlling method according to the first embodiment;

FIG. 9 is a flow diagram illustrating an example of operation of the UE of FIG. 5;

FIG. 10 is a diagram illustrating an example of a controlling method g according to the first embodiment;

FIG. 11 is a flow diagram illustrating an example of operation of the BS of FIG. 5;

FIG. 12 is a diagram illustrating an example of a controlling method according to the first embodiment;

FIG. 13 is a flow diagram illustrating an example of operation of the BS of FIG. 5;

FIG. 14 is a diagram illustrating an example of a controlling method according to the first embodiment;

FIG. 15 is a flow diagram illustrating an example of operation of the BS of FIG. 5;

FIG. 16 is a diagram illustrating an example of a controlling method according to the first embodiment; and

FIG. 17 is a flow diagram illustrating an example of operation of the BS of FIG. 5.

### DESCRIPTION OF EMBODIMENTS

Hereinafter, the embodiments discussed herein are described.

While inventing the present embodiments, observations were made regarding related art. Such observations include the following.

Here, as the related art, time scheduling and frequency scheduling in LTE wireless communication system are described. The time scheduling manages the wireless resource by each time unit (Sub-frame) and uses each sub-frame as a wireless resource for data transmission. The frequency scheduling manages the wires resource by each frequency unit (Sub-band) and uses each sub-band as a wireless resource for a wireless transmission.

Using the above time scheduling or frequency scheduling, the wireless communication system can preferentially allocate a wireless resource to a UE in a good channel state in accordance with a receiving signal quality of each sub-frame or sub-band of the downlink pilot channel or a Channel Quality Indicator (CQI) notified from each UE. Accordingly, the transmission efficiency and the throughput of the entire system can be improved.

In the above wireless communication system, at least one of UpLink (UL) CHannels (CHs) from a UE to the BS and DownLink (DL) CHs reverse to the UL CHs is sometimes shared by a number of UEs. Such a channel shared by a number of UEs is called a shared channel, and a shared DL channel is, for example, defined as Physical Downlink Shared CHannel (PDSCH) in LTE.

In transmitting DL data through a shared channel, the BS notifies information (e.g., a DL map) about resource allocating of each sub-band or sub-frame consisting of a wireless resource to a UE (signaling). Signaling uses, for example, the control channel (control CH). LTE defines such a control CH as Physical Downlink Control CHannel (PDCCH). The sub-band is sometimes called a Resource Block (RB).

In the wireless communication system, in transmitting DL data to the UE, the BS firstly divides the DL data in units of predetermined Transport Blocks (TBs) using a Radio Link Control (RLC) function (segmentation).

Then the BS determines a wireless resource to be allocated to a TB by a Media Access Controller (MAC) scheduler, and transmits to the UE using the allocated wireless resources. LTE transmits the DL data a single TB per sub-frame unless the technique of Multiple Input Multiple Output (MIMO) is adopted.

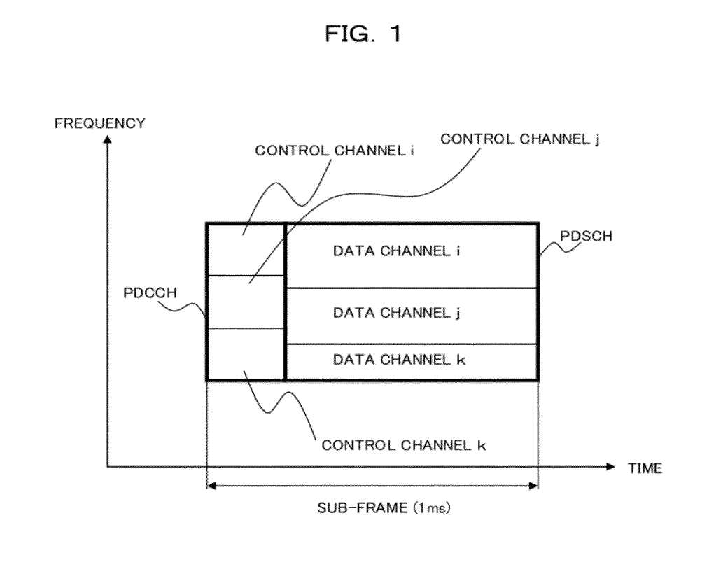

Here, FIG. 1 illustrates one example of a wireless resource extending in the frequency axis and the time axis. To a wireless resource of one sub-frame (for example, having a time width of 1 ms) of FIG. 1, PDCCH and PDSCH are exemplarily allocated; specifically, control CHs i, j, and k are allocated to PDCCH and data CHs PDSCH i, j, and k are allocated to PDSCH.

In transmitting data using the wireless resource of FIG. 1, the BS transmits the DL data for respective UEs using the data CHs i, j, and k. In addition, control information (DL scheduling information) about the wireless resource, the transmission format of the DL data, and the DL map are transmitted to respective UEs using the control CHs i, j, and k.

Upon receipt of a wireless signal from the BS, the UE demodulates and decodes the control CHs i, j, and k and detects the presence or the absence of control information destined for the local UE itself. In the event of detecting the presence of the control information destined for the local UE, the UE extracts information about allocation of a wireless resource and the transmission format from the control information. Then, on the basis of the control information and others, the UE extracts DL data destined for the local UE from the received data CHs i, j, and k, and modulates and decodes the extracted DL data.

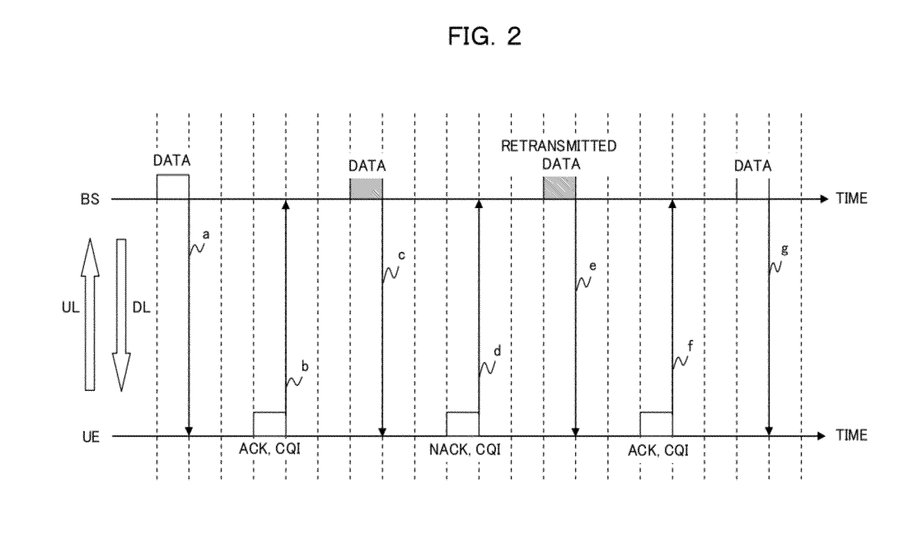

Besides, the UE detects the presence or the absence of an error in, for example, the DL data (see, symbol “a” in FIG. 2) that the BS transmits to the local UE. If no error is detected in the DL data received from the BS (i.e., the DL data is correctly received), the UE transmits an ACKnowledgement (ACK) signal to the BS (see symbol “b” in FIG. 2). Upon receipt of the ACK signal, the BS transmits the ensuing DL data of the DL data corresponding to the ACK signal to the UE for the first time (see symbol “c” in FIG. 2).

On the other hand, if an error is detected in the DL data received from the BS, the UE transmits a Negative ACKnowledgment (NACK) signal to the BS (see symbol “d” in FIG. 2). Upon receipt a NACK from the UE, the BS responsively retransmits the already-transmitted DL data corresponding to the NACK signal to the UE (see symbol “e” in FIG. 2).

The UE detects the presence or the absence of an error in the retransmitted data that the BS retransmits to the local UE, and if no error is detected in the retransmitted data, the UE transmits an ACK signal to the BS (see symbol “f” in FIG. 2). Upon receipt of the ACK signal from the UE, the BS transmits the ensuing DL data of the DL data corresponding to the ACK signal to the UE for the first time (see symbol “g” in FIG. 2).

The UE can measure the receiving quality (e.g., the quality of the transmission path) of the received DL data, and notify the channel quality information (e.g., CQI) as feedback information to the BS (see symbols “b”, “d”, and “f” in FIG. 2).

Upon a receipt of channel quality information from the UE, the BS adaptively changes the encoding rate and the modulating scheme to be applied to DL data on the basis of the received channel quality information. For example, when the level of the channel quality information is higher, the BS encodes and modulates DL data at a larger encoding rate and in a higher demodulating scheme. This control is called Adaptive Modulation and Coding (AMC).

In a wireless communication system adopting the above AMC scheme, a smaller encoding rate and a slower modulating scheme are applied when the level of the transmission path quality is low, so that error tolerance of data is improved. Conversely, when the level of the transmission path quality is high, a larger encoding rate and a faster demodulating rate are applied.

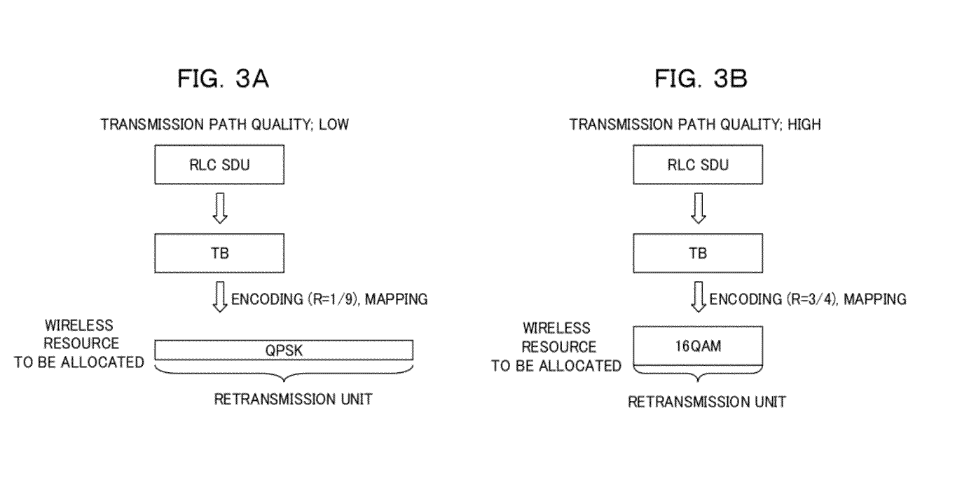

For example, as illustrated in FIG. 3A, the level of the transmission path is lower than a predetermined threshold, the DL (RLC Service Data Unit (SDU)), in units of TBs, is encoded at an encoding rate R= 1/9 and i modulated in the Quadrature Phase Shift Keying (QPSK) scheme, and then allocated to a wireless resource (mapping).

On the other hand, as illustrated in FIG. 3B, when the level of the transmission path is the threshold or more, the DL data is encoded at encoding rate R=¾ and modulated in 16 Quadrature Amplitude Modulation (16QAM) scheme in units of the TBs. Encoding at an encoding rate R= 1/9 causes the encoded data to be nine times longer than the data before the encoding while encoding rate R=¾ causes the encoded data to be 4/3 times longer than the data before the encoding. Modulation in QPSK can transmit two bits (four digits) per symbol while modulation in 16QAM can transmit four bits (16 digits) per symbol.

Accordingly, under various qualities of the transmission path, the size of a wireless resource allocated to a same size of a TB is smaller when the level of the transmission path quality is higher while the size is larger when the level of the transmission path quality is lower.

However, in the above retransmission controlling (e.g., Hybrid Automatic Repeat reQuest (HARQ)), the BS retransmits the DL data using a TB as a retransmission unit. The size of a TB is determined on the basis of the size of the DL data (RLC SDU) by the RLC function.

For the above, when the BS is retransmitting the DL data, an amount of data to be transmitted comes to be larger if the level of the transmission path quality is lower, so that a larger amount of a wireless resource is allocated to the retransmission. Consequently, the retransmission control limits another data transmission to use wireless resource, so that the throughput for each user and that for the entire system are lowered.

In order to suppress the size of a wireless resource to be allocated to a data retransmission unit, there is provided a method in which, if the size of an RLC SDU exceeds a predetermined upper limit, the data is sometimes divided into a number of TBs in a certain method.

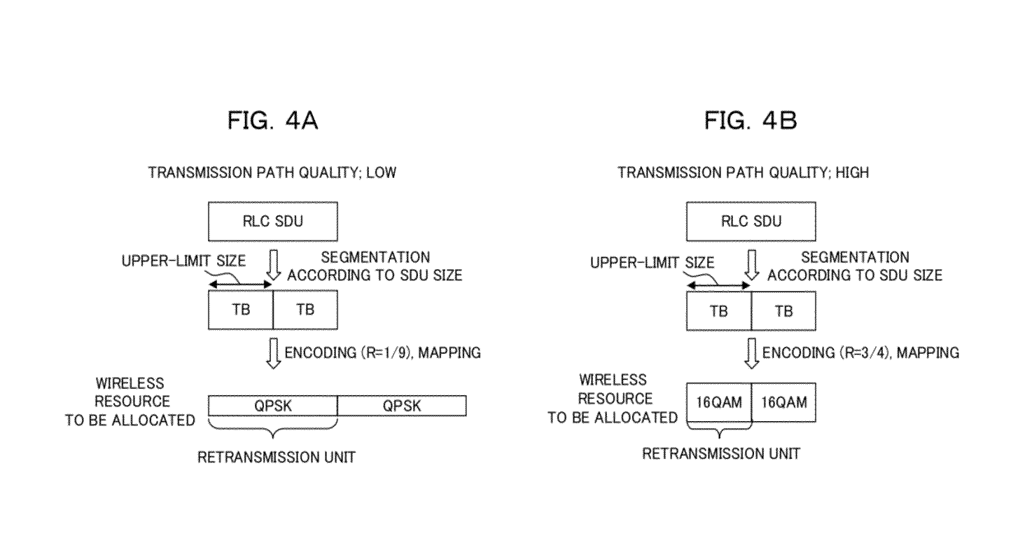

According to the method, as illustrated in FIG. 4A, the DL data is divided into a number of TBs, depending on the size of the RLC SDU. When the level of the transmission path quality is lower than the predetermined threshold, the DL data is encoded at an encoding rate R= 1/9 and is modulated in QSPK in units of prospective TBs, and is then mapped to the wireless resource.

On the other hand, as illustrated in FIG. 4B, when the level of the transmission path quality is the threshold or more, the DL data is also divided into a number of TBs, depending on the size of the RLC SDU. Then, the DL data is encoded at an encoding rate R=¾ and is modulated in 16QAM in units of prospective TBs, and is then mapped to the wireless resource.

However, the above method divides DL data into a number of TBs in accordance the size of an RLC SDU, which has difficulty in flexible control of data division.

The resultant increase in overhead due to the division and in the number of steps of controlling retransmission may increase an amount of data to be processed in the wireless communication system. In addition, there is a possibility of increasing an amount of information for ACK/NACK transmission. These phenomena also appear in another wireless communication system as well as an LTE wireless communication system.

### (1) First Embodiment

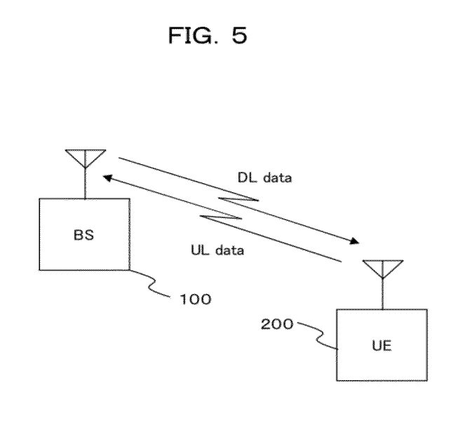

FIG. 5 illustrates an example of a wireless communication system according to the first embodiment. The wireless communication system of the present invention exemplarily includes a wireless base station (BS) 100 and a user equipment (UE) 200.

Here, the BS 100 can wirelessly communicate with the UE 200. For example, the BS 100 transmits DL data to the UE 200 while receives UL data from the UE 200. The number of BSs 100 and the number of UEs 200 are not limited to those of FIG. 5.

(1.1) BS 100

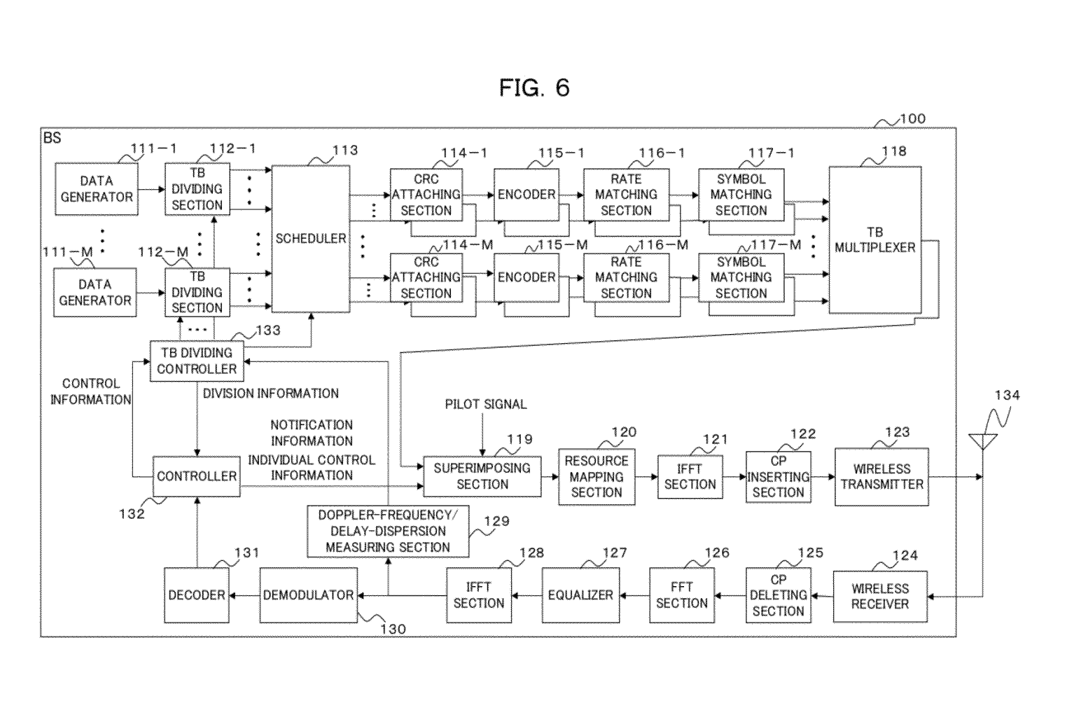

Next, an example of the configuration of the BS 100 is illustrated in FIG. 6.

As illustrated in FIG. 6, the BS 100 exemplarily includes data generators 111-1 through 111-M (M is a natural number), TB dividing sections 112-1 through 112-M, a scheduler 113, CRC attaching sections 114-1 through 114-M, encoders 115-1 through 115-M, a rate matching sections 116-1 through 116-M, symbol matching sections 117-1 through 117-M, a TB multiplexer 118, a superimposing section 119, a resource mapping section 120, an IFFT section 121, a CP inserting section 122, a wireless transmitter 123, a wireless receiver 124, a CP deleting section 125, an FFT section 126, an equalizer 127, an IFFT section 128, a Doppler-frequency/delay-spread measuring section 129, a demodulator 130, a decoder 131, a controller 132, a TB dividing controller 133, and an antenna 134.

Here, the antenna 134 serves as an interface to send data to and receive data from the UE 200. The antenna 134 transmits signals input from the wireless transmitter 123 to the UE 200 and outputs signals received from the UE 200 to the wireless receiver 124.

The wireless receiver 124 converts an UL signal that the antenna 134 receives to a baseband signal, and outputs the baseband signal to the CP deleting section 125.

The CP deleting section 125 deletes Cyclic Prefix (CP) included in the baseband signal obtained through the conversion by the wireless receiver 124 at a predetermined timing and outputs a signal after the deletion of the CP to the FFT section 126.

The FFT section 126 converts the signal after subjected to the CP deletion and input from the CP deleting section 125 into a frequency-domain signal through Fast Fourier Transform (FFT) and outputs the frequency-domain signal to the equalizer 127.

The equalizer 127 equalizes the signal output from the FFT section 126. In addition, the equalizer 127 of the first embodiment carries out reception processing (e.g., returning the phase rotated while being transmitted to an original state at the start of transmission) by means of channel compensation on signals after being distributed to respective channels using channel estimated values estimated by a channel estimated unit (not illustrated), and outputs to the signals after being subjected to the reception processing to the IFFT section 128.

The IFFT section 128 converts the frequency-domain signal from the equalizer 127 into a time-domain signal, and outputs the time-domain signal to both the demodulator 130 and the Doppler-frequency/delay-spread measuring section 129.

The Doppler-frequency/delay-spread measuring section 129 measures an amount (e.g., a Doppler frequency or delay spread) of delay of an UL signal received from the UE 200, and outputs the result of the measurement to the TB dividing controller 133.

The demodulator 130 demodulates the control CH and the data channel of the signal output from the IFFT section 128. The signal demodulated by the demodulator 130 is output to the decoder 131.

The decoder 131 decodes the signal demodulated by the demodulator 130, and outputs the decoded signal to the controller 132. The decoded signal includes, for example, a response signal (e.g., an ACK or NACK signal) from the UE 200, and channel quality information (e.g., CQI).

The controller 132 adaptively controls both or one of the encoding rate and the modulating scheme that are to be applied to DL data on the basis of channel quality information notified from the UE 200. For example, the controller 132 has a table in which a CQI value is associated with an encoding rate and a modulating scheme, and determines an encoding rate and a modulating scheme (MCS: Modulation and Coding Schemes) with reference to the table. The MCS determined by the controller 132 is output, as control information, to the TB dividing controller 133.

The controller 132 generates notification information and individual control information destined for the UE 200 on the basis of the division information input from the TB dividing controller 133, and outputs the generated information to the superimposing section 119. Division information relates to division processing carried out by the TB dividing controller 133, and includes, for example, the TB number (the division number) determined by the TB dividing controller 133, resource allocating information about a resource allocated to each TB, the MCS of each TB, and the HARQ process number of each TB. Notification information is transmitted to a number of UEs 200 while individual control information is transmitted each individual UE 200. Individual control information includes, for example, a transmission format of DL data and DL map information.

The controller 132 controls data retransmission in response to an ACK/NACK signal from the UE 200. For example, if receiving a NACK signal concerning DL data having a certain HARQ process number, the BS 100 can retransmit the DL data of the same process HARQ number to the UE 200 under the control of the controller 132. At that time, the controller 132 controls retransmission of DL data using, for example, a TB as a retransmission unit. On the other hand, if receiving an ACK signal concerning DL data having a certain HARQ process number, the BS 100 can transmit DL data subsequent to the DL data of the HARQ process number in question to the UE 200 for the first time under the control of the controller 132.

The TB dividing controller 133 determines the maximum amount (i.e., the upper-limit size) of data transmittable using a predetermined wireless resource on the basis of both or one of the above control information and the result of measuring the above amount of delay (Doppler frequency or delay spread), and controls data division by the TB dividing sections 112-1 through 112-M on the basis of the determined upper-limit size. For example, the TB dividing controller 133 controls data division by the TB dividing sections 112-1 through 112-M such that data pieces (TBs) obtained by the data division of the TB dividing sections 112-1 through 112-M and after being subjected to encoding and modulating have sizes equal to or less than the above upper-limit size. The size of a wireless resource to be allocated to each TB after the data division may correspond to an amount of data of a TB after being subjected to predetermined processing such as encoding and modulating.

Alternatively, the TB dividing controller 133 may set the upper-limit size such that the division number (i.e., the TB number) of data is a predetermined threshold or less. Thereby, the TB number is prevented from excessively increasing, inhibiting increase in overhead processing.

The data generators 111-1 through 111-M generate DL data (e.g., RLC SDU) destined for the respective UEs 200 (#1 through #M) and output the generated data to the respective corresponding TB dividing sections 112-1 through 112-M.

The TB dividing sections (data block generators) 112-1 through 112-M generate data blocks (e.g., TBs) based on data generated by the data generators 111-1 through 111-M and destined for the respective UEs 200. In addition, the TB dividing sections 112-1 through 112-M each divide DL data into a number (e.g., n (natural number) of TBs under control of the TB dividing controller 133.

For example, the TB dividing sections (data block generators) 112-1 through 112-M each divide data destined for the UE 200 by adjusting the size of each data block such that the amount of data of each data block after being subjected to encoding and modulating is equal to or less than the upper limit detailed above.

In addition, the TB dividing sections 112-1 through 112-M can further divide a TB into a number of sub-blocks. In this case, the controller 132 may regard a sub-block thus divided as a retransmission unit of retransmitting DL data to the UE 200 and retransmit each sub-block. This can further reduce the size of a data retransmission unit, so that the amount of a wireless resource consumed when data is retransmitted can be further reduced.

The scheduler 113 schedules (controls) transmission of the TBs generated by the TB dividing sections (data block generators) 112-1 through 112-M on the basis of scheduling information (including, for example, a modulating scheme, an encoding rate) about a DL signal destined for the UE 200. For example, the scheduler 113 can encode and modulate each TB in an encoding scheme of a larger encoding rate and a higher modulating scheme when the DL receiving quality based on the DL receiving quality information such as CQI information notified (as feedback information) from the UE 200 is better, and transmits the TB encoded and modulated to the UE 200.

The CRC attaching sections 114-1 through 114-M attach error detecting information (e.g., CRC) to the n TBs which are destined for the UEs 200 (#1 through #M) and which are output from the scheduler 113, and then output the TBs to the corresponding encoders 115-1 through 115-M.

The encoders 115-1 through 115-M perform error correcting encoding on the TBs containing CRCs attached by the CRC attaching sections 114-1 through 114-M in units of TBs using the encoding rate determined by the controller 132, and then output the TBs to the respective corresponding rate matching sections 116-1 through 116-M. Here, examples of the error correcting encoding are convolutional encoding and turbo encoding. An amount of data of each data block after being encoded by the encoders 115-1 through 115-M depends on the encoding rate of the encoding scheme applied. For example, when the encoding rate is larger, an amount of data after subjected to encoding by the encoders 115-1 through 115-M is smaller. In contrast, when the encoding rate is smaller, an amount of data after subjected to encoding by the encoders 115-1 through 115-M is larger.

Here, the encoders 115-1 through 115-M may encode all the TBs at the same encoding rate, or may alternatively encode some TBs at a different encoding rate from that for the remaining TBs. In other words, at least one of the TBs divided by the TB dividing sections 112-1 through 112-M may be encoded at an encoding rate different from an encoding rate at which at least another of the TBs is to be encoded by the encoders 115-1 through 115-M. Such some TBs encoded a larger encoding rate make it possible to further reduce an amount of a wireless resource being used.

The rate matching sections 116-1 through 116-M rate-match the encoded bits included in output signals from the encoders 115-1 through 115-M, and then outputs the resultant signals to the symbol matching sections 117-1 through 117-M. For example, the rate matching sections 116-1 through 116-M carry out repetition processing and puncturing processing on encoded bits such that the number of output bits coincides with the number of bits that the wireless network is able to transmit. Signals after being subjected to rate-matching processing by the rate matching sections 116-1 through 116-M are output to the corresponding symbol matching sections 117-1 through 117-M.

The symbol matching sections 117-1 through 117-M carry out symbol mapping (modulation) the signals encoded by the encoders 115-1 through 115-M in a modulating scheme (e.g., QPSK and 16QAM) determined by the controller 132. An amount of data of each data block after being modulated by the symbol matching sections 117-1 through 117-M depends on the modulating scheme that is applied. For example, when a faster modulating scheme is applied, the amount of data after modulated by the symbol matching sections 117-1 through 117-M is smaller. In other words, when a slower modulating scheme is applied, the amount of data after modulated by the symbol matching sections 117-1 through 117-M is larger.

Signals after being subjected to symbol mapping by the symbol matching sections 117-1 through 117-M. are then output to the TB multiplexer 118.

The symbol matching sections 117-1 through 117-M may modulate all the TBs divided by the TB dividing sections 112-1 through 112-M in the same modulating scheme or may alternatively modulate some of the TBs in a different modulating scheme from a modulating scheme applied to the remaining TBs. In other words, at least one of the TBs divided by the TB dividing sections 112-1 through 112-M may be modulated in a modulating scheme different from a modulating scheme to be applied to at least one of the remaining TBs by the symbol matching sections 117-1 through 117-M. Such some TBs modulated in a higher modulating scheme make it possible to further reduce an amount of a wireless resources being used.

For the above, the encoders 115-1 through 115-M and the symbol matching sections 117-1 through 117-M collectively function as an example of a transmitting data generator that encodes and modulates each of the plurality of data blocks generated by TB dividing sections 112-1 through 112-M in accordance with an encoding scheme and a modulating scheme that are to be applied.

The TB multiplexer 118 multiplexes a number of TBs which are destined for respective UEs 200 and which are output for symbol matching sections 117-1 through 117-M to a single sub-frame. A signal obtained by multiplexing by the TB multiplexer 118 is then output to the superimposing section 119.

The superimposing section 119 superimposes the signal output from the TB multiplexer 118, a pilot signal, the notification information, and the individual control information output from the controller 132, and outputs the superimposed signal to the resource mapping section 120.

The resource mapping section 120 maps the signal from the superimposing section 119 to a wireless resource (e.g., a sub-carrier frequency) assigned (allocated) by the scheduler 113.

The IFFT section 121 converts the signal obtained by mapping a transmitting modulated signal by the resource mapping section 120 into a time-domain signal through IFFT processing.

The CP inserting section 122 inserts CP, serving as a guard interval, into each transmission symbol of the time-domain signal obtained by the IFFT section 121.

The wireless transmitter 123 carries out wireless transmitting processing such as digital-to-analog (DA) conversion, up-conversion to a predetermined radio frequency (RF), and transmitting power control, on the signal containing CPs inserted by the CP inserting section 122. The RF signal after subjected to wireless transmitting processing by the wireless transmitter 123 is emitted from the antenna 134 to space to reach the UE 200.

In other words, the wireless transmitter 123 serves to function as an example of a transmitter that transmits data blocks generated by the encoders 115-1 through 115-M and the symbol matching sections 117-1 through 117-M using a predetermined wireless resource from the BS 100 to the UE 200.

(1.2) UE 200:

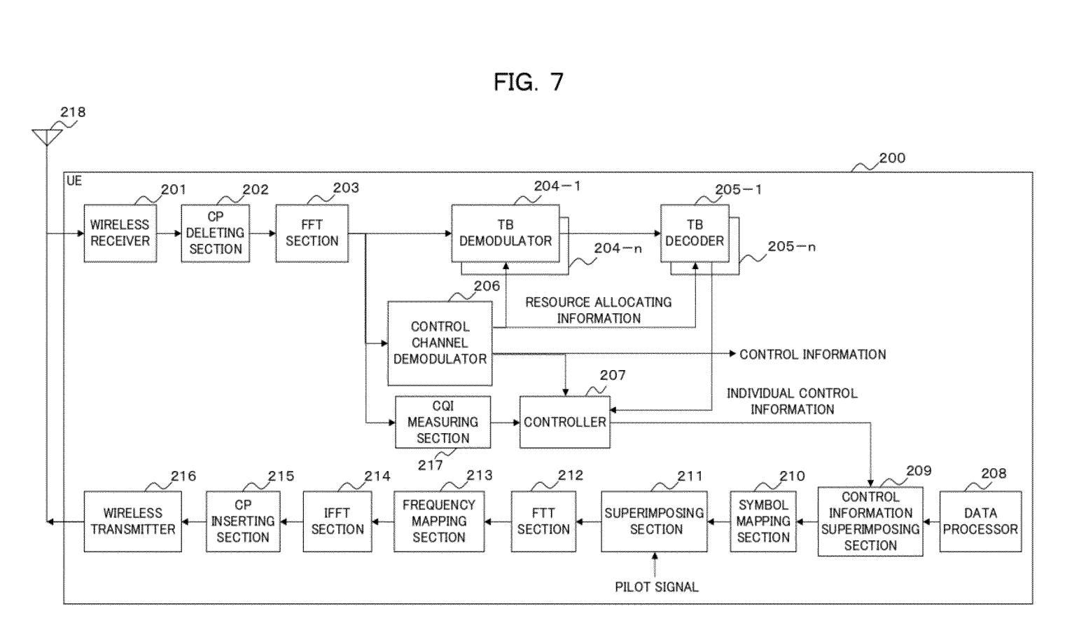

As illustrated in FIG. 7, the UE 200 exemplarily includes an antenna 218, a wireless receiver 201, a CP deleting section 202, an FFT section 203, TB demodulators 204-1 through 204-n, TB decoders 205-1 through 205-n, a control channel demodulator 206, a CQI measuring section 217, a controller 207, a data processor 208, a control information superimposing section 209, a symbol mapping section 210, a superimposing section 211, an FFT section 212, a frequency mapping section 213, an IFFT section 214, a CP inserting section 215, and a wireless transmitter 216.

The antenna 218 serves as an interface to transmit data to and receive data from the BS 100. Specifically, the antenna 218 transmits data input from the wireless transmitter 216 to the BS 100, and outputs a wireless signal received from the BS 100 to the wireless receiver 201.

The wireless receiver 201 converts a DL signal that the antenna 218 receives into a baseband signal, and then outputs the baseband signal to the CP deleting section 202.

Namely, the wireless receiver 201 functions as an example of a receiver that receives data from the BS 100.

The CP deleting section 202 deletes CPs contained in the baseband signal converted by the wireless receiver 201 at a predetermined timing, and outputs the baseband signal after the deletion of the CPs to the FFT section 203.

The FFT section 203 converts the baseband signal after the CP deletion into a frequency-domain signal through Fast Fourier Transform (FFT). The signal converted by the FFT section 203 is output to the TB demodulators 204-1 through 204-n, the control channel demodulator 206, the CQI measuring section 217.

The control channel demodulator 206 demodulates the control CH of the signal output from the FFT section 203. The result of the demodulation is regarded as resource allocating information, which is then output to the TB demodulators 204-1 through 204-n and the TB decoders 205-1 through 205-n. The resource allocating information includes, for example, the number of TBs, allocating resource information of a resource allocated to each TB, an MCS of each TB, and a HARQ process number of each TB. Other control information is output to the controller 207, and other processing sections (not illustrated).

The TB demodulators 204-1 through 204-n demodulate, on the basis of the resource allocating information from the control channel demodulator 206, the signal from the FFT section 203 in units of the n TBs divided by the BS 100. For example, the TB demodulators 204-1 through 204-n estimate distortion (i.e., a channel estimation value) of a DL transmission path between the BS 100 and the UE 200 by correlation calculating of a pilot signal received from the BS 100 and the replica of the pilot signal. On the basis of the calculated channel estimation value, the TB demodulators 204-1 through 204-n compensate for distortion that signals of the control CH and the data Ch are affected by (i.e., channel compensation), and carries out predetermined demodulation. The signals demodulated by the TB demodulators 204-1 through 204-n are output to the respective corresponding TB decoders 205-1 through 205-n.

On the basis of the resource allocating information from the control channel demodulator 206, the TB decoders 205-1 through 205-n demodulate output signals from the respective corresponding TB demodulators 204-1 through 204-n in units of n TBs divided by the BS 100. The TB decoders 205-1 through 205-n of the illustrated example detect the presence or the absence of an error of each of the TBs divided by the BS 100.

In other words, the TB decoders 205-1 through 205-n serves to function as an example of a determining section that determines whether DL data is correctly received in units of each TB divided in the above manner.

The CQI measuring section 217 measures the CQI of a received signal, and outputs the result of the measurement to the controller 207.

On the basis of the result of error detection in the TB decoders 205-1 through 205-n, the controller 207 requests the BS 100 to retransmit a TB that is not correctly received by the UE 200. For example, a retransmission request is included in individual control information that the controller 207 outputs to the control information superimposing section 209.

Specifically, the controller 207 functions as an example of a retransmitting controller that request the BS 100 to retransmit each of the TBs divided in the above manner according to the result of the determination in the TB decoders 205-1 through 205-n.

Besides, the controller 207 can output the CQI measured by the CQI measuring section 217 in the form of being included in the individual control information to the control information superimposing section 209. This notifies the CQI (as feedback) to the BS 100 at a predetermined frequency. Here, the individual control information includes, for example, CQI, ACK/NACK information, and a scheduling request.

The data processor 208 generates UL data destined for the BS 100, and outputs the generated data to the control information superimposing section 209. For example, the data processor 208 can regard a signal which is received from the BS 100 and which is then subjected to predetermined processing as UL data destined for the BS 100.

The control information superimposing section 209 superimposes the output from the data processor 208 and the individual control information from the controller 207, and then the superimposed data to the symbol mapping section 210.

The symbol mapping section 210 symbol-maps (i.e., modulates) the output from the control information superimposing section 209 in a predetermined modulating scheme (e.g., QPSK or 16QAM), and the outputs the resultant signal to the superimposing section 211.

The superimposing section 211 superimposes the signal output from the symbol mapping section 210, the pilot signal, and optionally another signal, and then outputs the superimposed signal to the FFT section 212.

The FFT section 212 converts the output signal from the superimposing section 211 into a frequency-domain signal (through FFT), and outputs the frequency-domain signal to the frequency mapping section 213.

The frequency mapping section 213 maps the signal from the FFT section 212 to a frequency assigned (allocated) by the controller 207. The signal frequency-mapped by the frequency mapping section 213 is output to the IFFT section 214.

The IFFT section 214 converts the signal obtained through mapping the transmitting modulated signal by the frequency mapping section 213 into a time-domain signal through IFFT, and then outputs the time-domain signal to the CP inserting section 215.

The CP inserting section 215 inserts a CP, serving as a guard interval, into each transmitting symbol of the time-domain signal obtained by the IFFT section 214, and outputs the signal containing CPs to the wireless transmitter 216.

The wireless transmitter 216 carries out predetermined wireless transmitting processing such as DA conversion, frequency conversion (up-conversion) to a predetermined RF, and transmitting power control, on the signal containing CPs inserted by the CP inserting section 215. The RF signal after subjected to wireless transmitting processing is emitted from the antenna 218 to space to reach the BS 100.

(1.3) Example of Operation of the Wireless Communication System:

Next, description will now be made in relation to an example of operation of the wireless communication system of this embodiment.

At the beginning, the BS 100 determines, on the basis of the CQI information notified from the UE 200 or other information, whether the level of the transmission path quality between the BS 100 and the UE 200 is less than the predetermined threshold.

If the BS 100 determines that the level of the transmission path quality is less than the threshold, the BS 100 adaptively changes, for example, the encoding rate and the modulating scheme to R= 1/9 and QPSK, respectively.

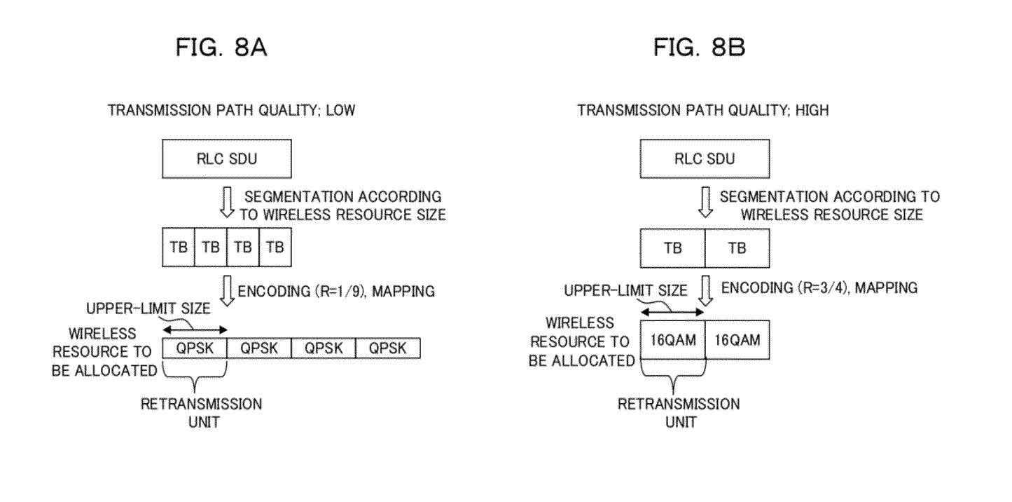

Furthermore, as illustrated in FIG. 8A, the BS 100 divides DL data into a number (four in the example of FIG. 8A) of TBs (segmentation) such that an amount of data of each TB after subjected to encoding and modulating is equal to or less than the above upper-limit size. Each TB obtained by division is encoded at the encoding rate R= 1/9 and modulated in QPSK scheme, mapped to a wireless resource, and then transmitted from the BS 100 to UE 200. At that time, encoding at the encoding rate (R= 1/9) and modulating in the modulation scheme (QPSK scheme) causes each TB to have an increased amount of data, which is however equal to or less than the upper-limit size (see the QPSK block in FIG. 8) as illustrated in FIG. 8.

On the other hand, if the BS 100 determines that the level of the transmission path quality is equal to or higher than the predetermined threshold, the BS 100 adaptively changes, for example, the encoding rate and the modulating scheme to R=¾ and 16QAM, respectively.

Furthermore, as illustrated in FIG. 8B, the BS 100 divides DL data into a number (two in the example of FIG. 8B) of TBs (segmentation) such that an amount of data of each TB after subjected to encoding and modulating is equal to or less than the above upper-limit size. Each TB obtained by division is encoded at the encoding rate R=¾ and modulated in 16QAM scheme, mapped to the wireless resource, and then transmitted from the BS 100 to UE 200.

As the above, if the level of the transmission path quality is low, a lower encoding rate and a lower modulating scheme are applied, so that the amount (the size of wireless resource to be used) of data to be transmitted as DL data increases and thereby the DL data is divided into a larger number of TBs. In contrast, the level of the transmission path quality is high, an amount of data to be transmitted as DL data is less than the amount of data to be transmitted as the same DL data when the transmission path quality is low, so that the amount of the DL data to be transmitted is less and the DL data is divided into a smaller number of TBs.

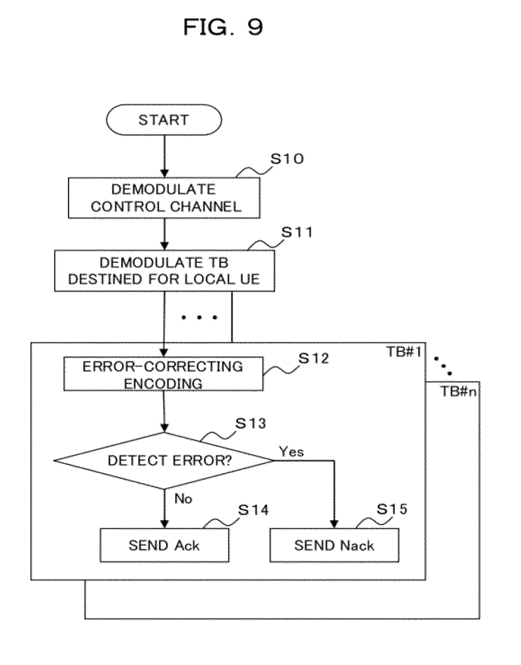

As illustrated in FIG. 9, upon receipt of TBs from the BS 100, the UE 200 firstly demodulates the received control channel (step S10).

Next, on the basis of the result of demodulating the control channel, the UE 200 extracts one or more TBs destined for the local UE 200, and demodulates the extracted the TBs (step S11).

Then, the UE 200 performs error-correcting encoding each of a number of TBs (TB#1 through TB#n (n is a natural number)) destined for local UE 200 (step S12), and detects an error (step S13).

If an error is found in one of the received TBs (Yes route in step S13), the UE 200 transmits a NACK signal to the BS 100 (step S15). Conversely, if no error is found in the received TBs (No route in step S13), the UE 200 transmits an ACK signal to the BS 100 (step S14).

If receipt of an ACK signal from the UE 200, the BS 100 determines that the TBs previously transmitted correctly undergo receiving processing, and transmits next new data to the UE 200. On the other hand, if receipt of a NACK signal from the UE 200, the BS 100 determines that one of the TBs previously transmitted does not correctly undergo receiving processing, and retransmits the TB corresponding to the HARQ process number in the received NACK signal to the UE 200.

According to the control method of the present example, the size (retransmission unit) of wireless resource allocated to data to be retransmitted can be controlled to be equal to or less than the upper-limit size determined by the controller 132 regardless of the size of DL data before the division and the transmission path quality.

For the above, since DL data to be allocated to a large size of wireless resource is divided into a large number of TBs (see, for example, FIG. 8A), efficiency in retransmission of data can be improved. On the other hand, DL data to be allocated to a relatively small size of a wireless resource is divided into a sufficiently small number of TBs (see, for example, FIG. 8B), it is possible to reduce the overhead related to the division to TB and thereby improve data processing efficiency. The controlling method of this embodiment can decrease the variation of the size of a wireless resource to be allocated to a TB obtained by dividing DL data, so that efficiency in multiplexing in scheduling for multiple users can be enhanced.

(1.4) Various Kinds of Wireless Resource:

There are a number of kinds of wireless resource to be used to transmit TBs. Hereinafter, description will now be made in relation to examples of operation of the wires communication system using the respective kinds of wireless resource.

(1.4.1) A Case where the Wireless Resource is a Frequency Band:

The BS 100 can allocate a wireless resource in the form of a frequency band to the data CH for transmitting TBs, and transmit the data to the UE 200.

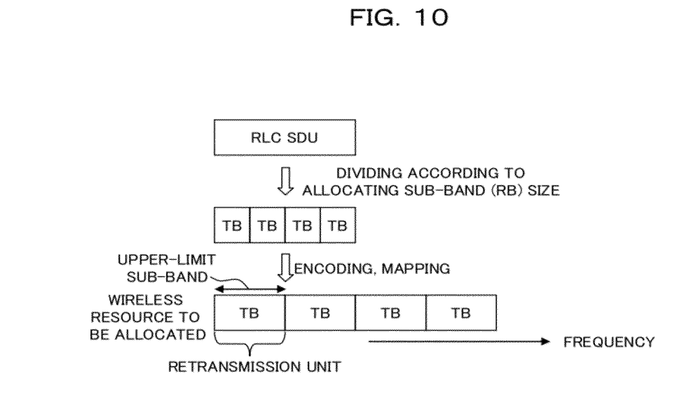

For this purpose, as illustrated in FIG. 10, the BS 100 divides the DL data into a number (four in the example of FIG. 10) of TBs (segmentation) such that each TB after subjected to encoding and modulating has a data amount (the size of a sub-band (RB) allocated to the TB) of the above-described upper-limit size (upper-limit sub-band) or less. The upper-limit size may depend on a delay spread value of the transmission path between the BS 100 and the UE 200 which value is measured by the Doppler-frequency/delay-spread measuring section 129.

In the BS 100, the TBs obtained by the TB dividing sections 112-1 through 112-M are encoded and modulated, for example, at an encoding rate and in modulating scheme determined by the controller 132 according to the transmission path quality, mapped to the above frequency band, and then transmitted to UE 200.

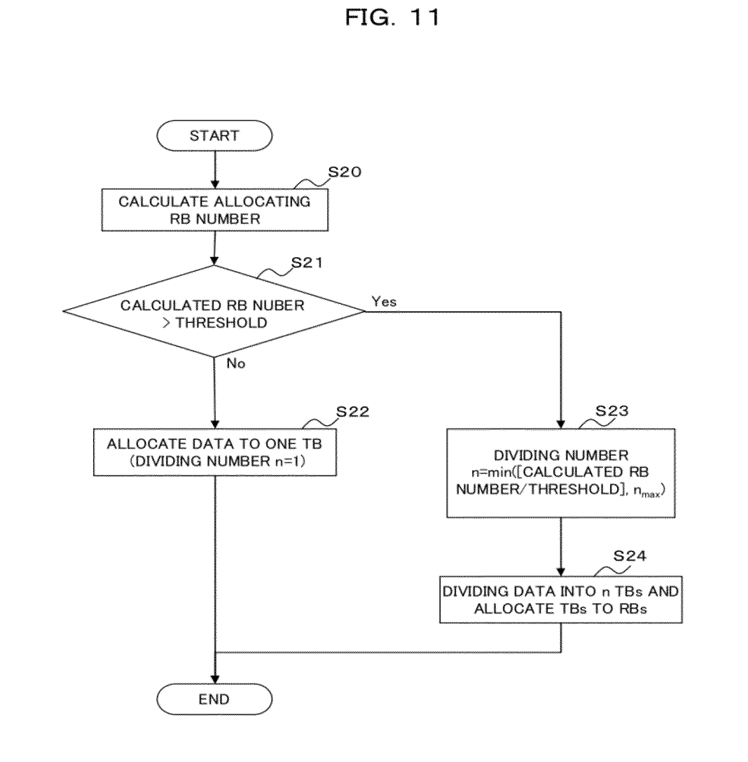

Here, an example of operation of the BS 100 of this example is illustrated in FIG. 11.

As illustrated in FIG. 11, the TB dividing controller 133 firstly calculates the RB number (i.e., the number of RBs) to be allocated when the DL data before the division is encoded and demodulated at an encoding rate and in a modulating scheme determined in the controller 132 (step S20).

Next, the TB dividing controller 133 determines whether the calculated RB number is larger than a predetermined threshold (step S21). The threshold may depend on the delay spread value of the transmission path between the BS 100 and the UE 200 as detailed above. For example, the threshold can be set to be large when the delay spread value is small, and the threshold can be set to be small when the delay spread value is large.

If the calculated RB number is determined to be the threshold value or less (No route of step S21), the TB dividing controller 133 does not divide the DL data and does allocate the entire DL data to a single TB (step S22). On the other hand, if the calculated RB number is determined to be more than the threshold (Yes route of step S21), the TB dividing controller 133 divides the DL data into a number of TBs. The dividing number n of TBs into which the DL data is to be divided is determined by following Formula (1) (step S23). Hereinafter, the dividing number n represents the number of TBs into which DL data is divided.

n=min([(calculated RB number)/threshold],nₘₐₓ) (1)

Here, the term nₘₐₓ represents the upper limit of the dividing number n, and may sometimes be determined by the BS 100 such that the number (the dividing number n) of TBs as a result of dividing the DL data is not excessively large. For example, in this case, setting the dividing number n of the DL data to be the closest value to the threshold but not exceeding the upper limit nₘₐₓ of the dividing number by the BS 100 makes it possible to enhance the data retransmission efficiency, inhibiting the overhead resulting from division of the DL data.

Then, the BS 100 divides the DL data into the dividing number n of TBs determined according to Formula (1), allocates one of the RBs to each TB (step S24), and transmits the TBs to the UE 200.

Here, the above series of operation will be seen from each functional layer of the BS 100. For example, the RLC of the BS 100 is notified of allocatable wireless resource information (the size of a transmittable TB, sub-frames to be transmitted, and the number of RBs allocatable to the sub-frames) from a lower layer (MAC Layer). Furthermore, if the RB number notified from the MAC Layer exceeds a predetermined threshold, the RLC generates a number of TBs such that the number of RBs to be allocated is the threshold or less, and transmits the generated TBs to the MAC Layer.

The MAC Layer of the BS 100 schedules TBs according to, for example, the priorities of respective users and determines physical channel resource that is allocated each TB.

The physical layer of the BS 100 carries out CRC attachment, error-correcting encoding, rate matching, scrambling, symbol mapping, and others on each TB, and maps the TB to the physical channel on the basis of DL scheduling information. The BS 100 may transmit a number of TBs divided by the RLC using a single sub-frame, or may apply MCS different with TBs.

As illustrated in FIG. 9, upon receipt a DL signal from the BS 100, the UE 200 carries out error-correcting decoding and error detecting on each of the TBs received from the BS 100, and notifies the result of the error detecting, as feedback control information (ACK/NACK information) to the BS 100.

Upon receipt of the ACK/NACK information from the UE 200, the BS 100 controls retransmission of one or more TBs that are not correctly received by the UE 200 based on the ACK/NACK information by means of the HARQ.

(1.4.2) A Case where the Wireless Resource is a Time Length:

The BS 100 can allocate a wireless resource in the form of a time length to the data CH for transmitting TBs, and transmit the data to the UE 200.

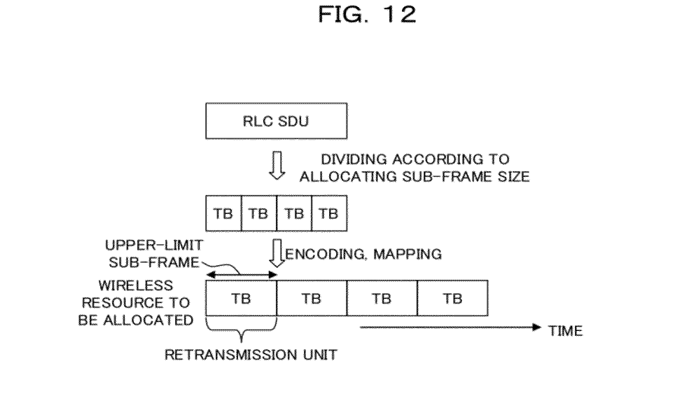

For this purpose, as illustrated in FIG. 12, the BS 100 divides the DL data into a number (four in the example of FIG. 12) of TBs (segmentation) such that each TB after subjected to encoding and modulating has a data amount (the size of a time length (sub-frame) allocated to the TB) of the above-described upper-limit size (upper-limit sub-band) or less. The upper-limit size may depend on a delay spread value of the transmission path between the BS 100 and the UE 200 which value is measured by the Doppler-frequency/delay-spread measuring section 129.

In the BS 100, the TBs obtained by the TB dividing sections 112-1 through 112-M are encoded and modulated, for example, at an encoding rate and in modulating scheme determined by the controller 132 according to the transmission path quality, mapped to the above sub-frame, and then transmitted to UE 200.

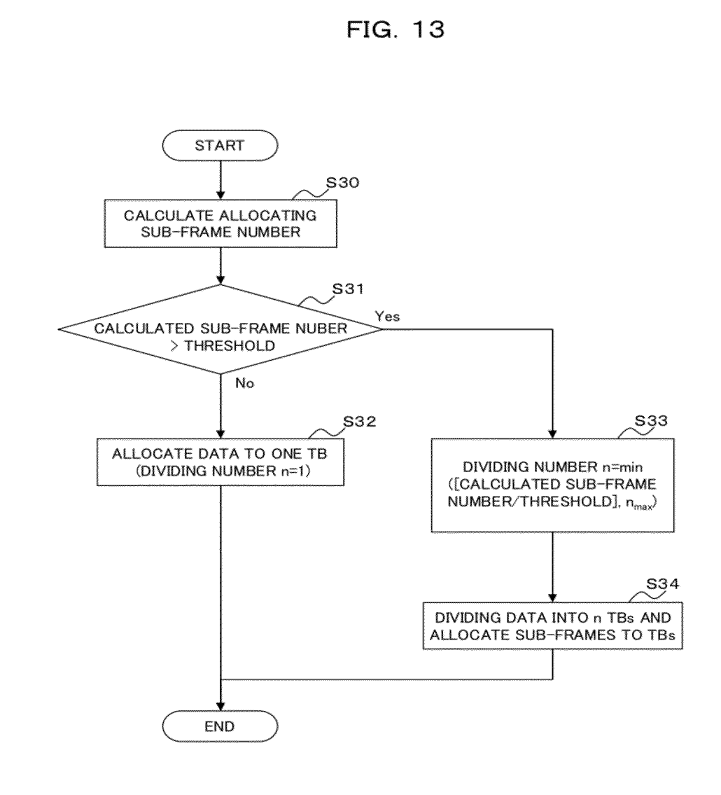

Here, an example of operation of the BS 100 of this example is illustrated in FIG. 13.

As illustrated in FIG. 13, the TB dividing controller 133 firstly calculates the sub-frame number (i.e., the number of sub-frames) to be allocated when the DL data before the division is encoded and demodulated at an encoding rate and in a modulating scheme determined in the controller 132 (step S30).

Next, the TB dividing controller 133 determines whether the calculated sub-frame number is larger than a predetermined threshold (step S31). The threshold may depend on the Doppler frequency of the transmission path between the BS 100 and the UE 200 as detailed above. For example, the threshold can be set to be large when the Doppler frequency is small, and the threshold can be set to be small when the Doppler frequency is large.

If the calculated sub-frame number is determined to be the threshold value or less (No route of step S31), the TB dividing controller 133 does not divide the DL data and does allocate the entire DL data to a single TB (step S32). On the other hand, if the calculated sub-frame number is determined to be more than the threshold (Yes route of step S31), the TB dividing controller 133 divides the DL data into a number of TBs. The dividing number n of TBs into which the DL data is to be divided is determined by following Formula (2) (step S33).

n=min([(calculated sub-frame number)/threshold],nₘₐₓ) (2)

Then, the BS 100 divides the DL data into the dividing number n of TBs determined according to Formula (2), allocates one of the sub-frames to each TB (step S34), and transmits the TBs to the UE 200.

Here, the above series of operation will be seen from each functional layer of the BS 100. For example, the RLC of the BS 100 is notified of allocatable wireless resource information (the size of a transmittable TB and sub-frames to be transmitted) from a lower layer (MAC Layer). Furthermore, if the RB number notified from the MAC Layer exceeds the predetermined threshold, the RLC generates a number of TBs such that the number of RBs to be allocated is the threshold or less, and transmits the generated TBs to the MAC Layer.

The MAC Layer of the BS 100 schedules TBs according to, for example, the priorities of respective users and determines physical channel resource that is allocated each TB.

The physical layer of the BS 100 carries out CRC attachment, error-correcting encoding, rate matching, scrambling, symbol mapping, and others on each TB, and maps the TB to the physical channel on the basis of DL scheduling information. The BS 100 may transmits a number of TBs divided by the RLC using a single sub-frame, or may apply MCS different with TBs.

As illustrated in FIG. 9, upon receipt a DL signal from the BS 100, the UE 200 carries out error-correcting decoding and error detecting on each of the TBs received from the BS 100, and notifies the result of the error detecting, as feedback control information (ACK/NACK information) to the BS 100.

Upon receipt of the ACK/NACK information from the UE 200, the BS 100 controls retransmission of one or more TBs that are not correctly received by the UE 200 based on the ACK/NACK information by means of HARQ.

(1.4.3) A Case where the Wireless Resource is a Product of a Frequency Band and a Time Length:

The BS 100 can allocate a wireless resource in the form of a product of a resource (RB) in the frequency direction and a resource (sub-frame) in the time direction to the data CH for transmitting TBs, and transmit the data to the UE 200.

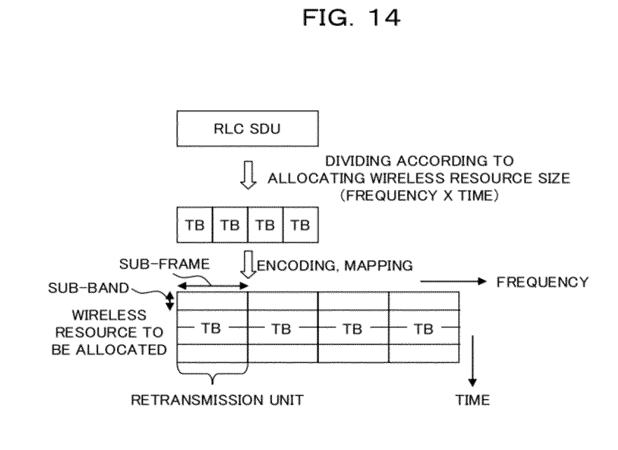

For this purpose, as illustrated in FIG. 14, the BS 100 divides the DL data into a number (four in the example of FIG. 14) of TBs (segmentation) such that each TB after subjected to encoding and modulating has a data amount (the size of a wireless resource which is defined in terms of the product of frequency and time and which is to be allocated to the TB) of the above-described upper-limit size or less. The upper-limit size may depend on a product of a Doppler frequency and a delay spread value of the transmission path between the BS 100 and the UE 200 which frequency and value are measured by the Doppler-frequency/delay-spread measuring section 129.

In the BS 100, the TBs obtained by the TB dividing sections 112-1 through 112-M are encoded and modulated, for example, at an encoding rate and in modulating scheme determined by the controller 132 according to the transmission path quality, mapped to the above wireless resource (a region defined in terms of frequency×time) and then transmitted to UE 200.

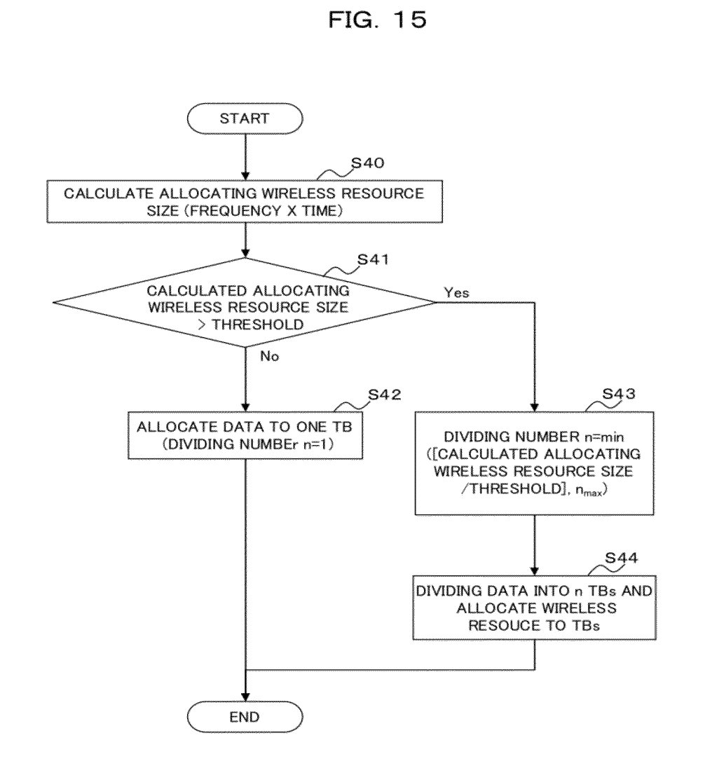

Here, an example of operation of the BS 100 of this example is illustrated in FIG. 15.

As illustrated in FIG. 15, the TB dividing controller 133 firstly calculates the size of a wireless resource (frequency×time) to be allocated when the DL data before the division is encoded and demodulated at an encoding rate and in a modulating scheme determined in the controller 132 (step S40).

Next, the TB dividing controller 133 determines whether the calculated wireless resource size is larger than a predetermined threshold (step S41). The threshold may depend on the product of the delay spread value of the transmission path between the BS 100 and the UE 200 and the Doppler frequency of the transmission path as described above. For example, the threshold can be set to be large when the product of the delay spread value and the Doppler frequency is small, and the threshold can be set to be small when the product of the delay spread value and the Doppler frequency is large.

If the calculated wireless resource size is determined to be the threshold value or less (No route of step S41), the TB dividing controller 133 does not divide the DL data and does allocate the entire DL data to a single TB (step S42). On the other hand, if the calculated wireless resource size is determined to be more than the threshold (Yes route of step S41), the TB dividing controller 133 divides the DL data into a number of TBs. The dividing number n of TBs into which the DL data is to be divided is determined by following Formula (3) (step S43).

n=min([(calculated wireless resource size)/threshold],nₘₐₓ) (3)

Then, the BS 100 divides the DL data into the dividing number n of TBs determined according to Formula (3), allocates one of the a wireless resource in the form of a product of a frequency band and a time length to each TB (step S44), and transmits the TBs to the UE 200.

Here, the above series of operation is seen from each functional layer of the BS 100. For example, the RLC of the BS 100 is notified of allocatable wireless resource information (the size of a transmittable TB, sub-frames to be transmitted, and the number of RBs allocatable to each sub-frames) from a lower layer (MAC Layer). Furthermore, if the RB number notified from the MAC Layer exceeds the predetermined threshold, the RLC generates a number of TBs such that the number of RBs to be allocated is the threshold or less, and transmits the generated TBs to the MAC Layer.

The MAC Layer of the BS 100 schedules TBs according to, for example, the priorities of respective users and determines physical channel resource that is allocated each TB.

The physical layer of the BS 100 carries out CRC attachment, error-correcting encoding, rate matching, scrambling, symbol mapping, and others on each TB, and maps the TB to the physical channel on the basis of DL scheduling information. The BS 100 may transmit a number of TBs divided by the RLC using a single sub-frame, or may apply MCS different with TBs.

As illustrated in FIG. 9, upon receipt a DL signal from the BS 100, the UE 200 carries out error-correcting decoding and error detecting on each of the TBs received from the BS 100, and notifies the result of the error detecting, as feedback control information (ACK/NACK information) to the BS 100.

Upon receipt of the ACK/NACK information from the UE 200, the BS 100 controls retransmission of one or more TBs that are not correctly received by the UE 200 based on the ACK/NACK information by means of HARQ.

(1.4.4) A Case where the Wireless Resource is Spreading Codes or Transmitting Electric Power:

The BS 100 may transmit data in a Code Division Multiple Access (CDMA) scheme. At that time, the BS 100 can allocate a wireless resource in the form of the number of spreading code to be allocated to the TBs (or transmitting electric power of TBs) to the data CH for transmitting TBs and transmit the data to the UE 200.

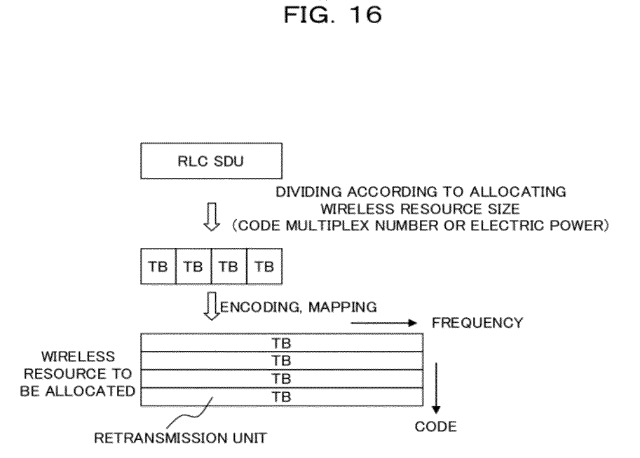

For this purpose, as illustrated in FIG. 16, the BS 100 divides the DL data into a number (four in the example of FIG. 16) of TBs (segmentation) such that each TB after subjected to encoding and modulating has a data amount (the number of spreading codes (or transmitting electric power) to be allocated to the TB) of the above-described upper-limit size or less. Then, the TBs obtained by the TB dividing sections 112-1 through 112-M are encoded and modulated, for example, at an encoding rate and in modulating scheme determined by the controller 132 according to the transmission path quality, mapped to the above spreading codes, and then transmitted to UE 200.

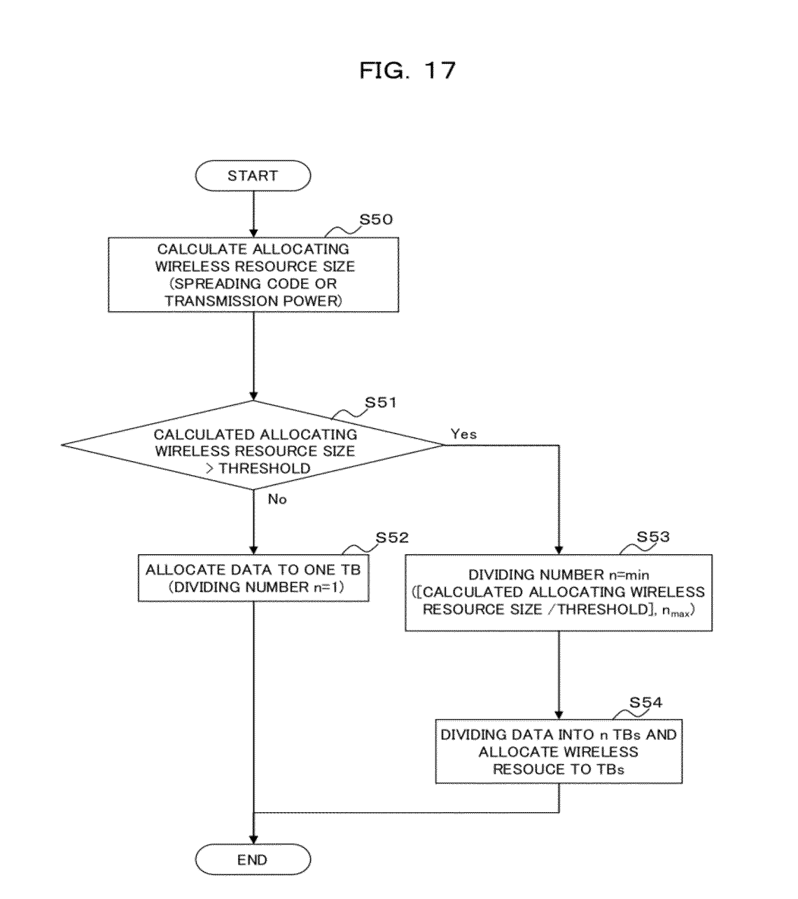

Here, an example of operation of the BS 100 of this example is illustrated in FIG. 17.

As illustrated in FIG. 17, the TB dividing controller 133 firstly calculates the wireless resource size (the number of spreading codes or transmitting power source) to be allocated when the DL data before the division is encoded and demodulated at an encoding rate and in a modulating scheme determined in the controller 132 (step S50).

Next, the TB dividing controller 133 determines whether the calculated wireless resource size is larger than a predetermined threshold (step S51).

If the calculated wireless resource size is determined to be the threshold value or less (No route of step S51), the TB dividing controller 133 does not divide the DL data and does allocate the entire DL data to a single TB (step S52). On the other hand, if the calculated wireless resource size is determined to be more than the threshold (Yes route of step S51), the TB dividing controller 133 divides the DL data into a number of TBs. The dividing number n of TBs into which the DL data is to be divided is determined by following Formula (4) (step S53).

n=min([(calculated wireless resource size)/threshold],nₘₐₓ) (4)

Then, the BS 100 divides the DL data into the dividing number n of TBs determined according to Formula (4), allocates one of the a wireless resource in the form of the number of spreading codes or the transmitting electric power) to each TB (step S54), and transmits the TBs to the UE 200.

Here, the above series of operation will be seen from each functional layer of the BS 100. For example, the RLC of the BS 100 is notified of allocatable wireless resource information (the size of a transmittable TB, sub-frames to be transmitted, the number of RBs allocatable to each sub-frames, and a transmitting electric power) from a lower layer (MAC Layer). Furthermore, if the RB number notified from the MAC Layer exceeds the predetermined threshold, the RLC generates a number of TBs such that the number of RBs to be allocated is the threshold or less, and transmits the generated TBs to the MAC Layer.

The MAC Layer of the BS 100 schedules TBs according to, for example, the priorities of respective users and determines physical channel resource that is allocated each TB.

The physical layer of the BS 100 carries out CRC attachment, error-correcting encoding, rate matching, scrambling, symbol mapping, and others on each TB, and maps the TB to the physical channel on the basis of DL scheduling information. The BS 100 may transmit a number of TBs divided by the RLC using a single sub-frame, or may apply MCS different with TBs.

As illustrated in FIG. 9, upon receipt a DL signal from the BS 100, the UE 200 carries out error-correcting decoding and error detecting on each of the TBs received from the BS 100, and notifies the result of the error detecting, as feedback control information (ACK/NACK information) to the BS 100.

Upon receipt of the ACK/NACK information from the UE 200, the BS 100 controls retransmission of one or more TBs that are not correctly received by the UE 200 based on the ACK/NACK information by means of HARQ.

As the above, the controlling method of this example can control the size (retransmission unit) of a wireless resource to be allocated to retransmission data to be a predetermined upper-limit size or less regardless of a data size before the division and the quality of the transmission path.

Accordingly, since DL data requiring a large size of a wireless resource to be allocated to is divided into a large number of TBs, the efficiency in retransmitting data can be improved. On the other hand, for DL data only requiring a relatively small size of a wireless resource to be allocated to, the dividing number into TBs is suppressed, so that overhead due to the division can be decreased and the efficiency in data processing can be enhanced.

Furthermore, the controlling method of this example can decrease the variation of the size of wireless resource to be allocated to a TB obtained by dividing DL data, so that efficiency in multiplexing in scheduling for multiple users can be enhanced.

(2) Others:

The configurations and the functions of the BS 100 and the UE 200 may be selected, unselected, and combined according to the requirement. Each function of the BS 100 and the UE 200 may be performed, for example, by a processor executing a program stored in a memory.

For example, the above description assumes a wireless transmitter and a wireless receiver are in the wireless communication system are exemplified by the BS 100 and the UE 200, respectively. Alternatively, the UE 200 and the BS 100 may function as an example of a wireless transmitter and an example of a wireless receiver, respectively. Furthermore, the BS 100 and the UE 200 each may serve as both wireless transmitter and wireless receiver.

The wireless resource in the above example is assumed to be a frequency band, a time length, a product of a frequency band and a time length, or the number of spreading code (transmitting electric power). The wireless resource should by no means be limited to these examples.

Each configuration and each function of the BS 100 and the UE 200 may be included in another entity according to the requirement.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments have been described in detail, it should be understood that the various changes, substitutions, and alterations could be made hereto without departing from the spirit and scope of the invention.

What is claimed is:

1. A transmission controlling method for a wireless transmitter which transmits data to a wireless receiver, the transmission controlling method comprising:
generating a plurality of data blocks based on the data destined for the wireless receiver;
encoding and modulating each of the plurality of data blocks in accordance with an encoding scheme and a modulating scheme that are to be applied; and
transmitting the plurality of data blocks encoded and modulated using a wireless resource, wherein
the generating of the plurality of data blocks comprising adjusting the size of each of the plurality of data blocks by dividing the data destined for the wireless receiver such that an amount of data of each of the plurality of data blocks encoded and modulated is equal to or less than an amount of maximum data that the wireless transmitter is able to transmit using the wireless resource when the encoding scheme and the modulating scheme are applied.

2. The transmission controlling method according to claim 1, wherein the amount of data of each of the plurality of data blocks encoded and modulated depends on an encoding rate of the encoding scheme or the modulating scheme that is to be applied.

3. The transmission controlling method according to claim 2, wherein at least the encoding rate or the modulating scheme that is to be applied depends on communication quality of a wireless transmission path between the wireless transmitter and the wireless receiver.

4. The transmission controlling method according to claim 1, wherein the wireless resource is a frequency band.

5. The transmission controlling method according to claim 4, wherein the amount of maximum data that the wireless transmitter is able to transmit using the wireless resource depends on a delay spread value of the wireless transmission path between the wireless transmitter and the wireless receiver.

6. The transmission controlling method according to claim 1, wherein the wireless resource is a time length.

7. The transmission controlling method according to claim 6, wherein the amount of maximum data that the wireless transmitter is able to transmit using the wireless resource depends on a Doppler frequency of a wireless transmission path between the wireless transmitter and the wireless receiver.

8. The transmission controlling method according to claim 1, wherein the wireless resource is a product of a frequency band and a time length.

9. The transmission controlling method according to claim 8, wherein the amount of maximum data that the wireless transmitter is able to transmit using the wireless resource depends on a product of a delay spread value of a wireless transmission path between the wireless transmitter and the wireless receiver and a Doppler frequency of the wireless transmission path.

10. The transmission controlling method according to claim 1, wherein the wireless resource is the number of spreading codes to be allocated to the data destined for the wireless receiver or transmission electric power of the data destined for the wireless receiver.

11. The transmission controlling method according to claim 1, wherein the wireless transmitter retransmits each of the plurality of data blocks as a retransmission unit of data to the wireless receiver.

12. The transmission controlling method according to claim 1, further comprising:
dividing each of the plurality of data blocks into a plurality of sub-blocks; and
retransmitting each of the plurality of sub-blocks as a retransmission unit of data to the wireless receiver.

13. The transmission controlling method according to claim 1, wherein at least one data block of the plurality of data blocks is encoded or modulated in accordance with an encoding rate or a modulating scheme different from that applied to at least another data block of the plurality of data blocks.

14. The transmission controlling method according to claim 1, wherein the amount of maximum data that the wireless transmitter is able to transmit using the wireless resource is determined such that the number of the divided data blocks is equal to or less than a predetermined threshold value.

15. A wireless transmitter that transmits data to a wireless receiver, the wireless transmitter comprising:
a data block generator that generates a plurality of data blocks based on the data destined for the wireless receiver;
a transmitting data generator that encodes and modulates each of the plurality of data blocks in accordance with an encoding scheme and a modulating scheme that are to be applied; and
a transmitter that transmits the plurality of data blocks encoded and modulated by the transmitting data generator using a wireless, wherein
the transmitting data generator adjusts the size of each of the plurality of data blocks by dividing the data destined for the wireless receiver such that an amount of data of each of the plurality of data blocks encoded and modulated is equal to or less than an amount of maximum data that the wireless transmitter is able to transmit using the wireless resource when the encoding scheme and the modulating scheme are applied.

16. The wireless transmitter according to claim 15, wherein the transmitter transmits each of the plurality of data blocks as a retransmission unit of data to the wireless receiver.

17. A wireless receiver that receives data from a wireless transmitter, the receiving device comprising:
a receiver that receives, from the wireless transmitter, a plurality of data blocks into which the data is divided such that an amount of data of each of the plurality of data blocks encoded and modulated in an encoding scheme and a modulating scheme is equal to or less than an amount of maximum data that the wireless transmitter is able to transmit using a wireless resource when the encoding scheme and the modulating scheme are applied
a determining section that determines whether the data is correctly received in units of the plurality of data blocks;
a retransmitting controller that requests the wireless transmitter to retransmit each of the plurality of data blocks according to the result of the determination in the determining section.

18. A communication system including a wireless receiver and a wireless transmitter which transmits data to the wireless receiver, the system comprising:
a data block generator that generates a plurality of data blocks based on the data destined for the wireless receiver;
a transmitting data generator that encodes and modulates each of the plurality of data blocks in accordance with an encoding scheme and a modulating scheme that are to be applied; and
a transmitter that transmits the plurality of data blocks using a wireless resource, wherein
the transmitting data generator adjusts the size of each of the plurality of data blocks by dividing the data destined for the wireless receiver such that an amount of data of each of the plurality of data blocks encoded and modulated is equal to or less than an amount of maximum data that the wireless transmitter is able to transmit using the wireless resource when the encoding scheme and the modulating scheme are applied.
